(19) United States
(12) Patent Application Publication
(10) Pub. No.: US 2024/0375113 A1
(43) Pub. Date: Nov. 14, 2024

(54) VIAL CONTAINER

(71) Applicant: MESO SCALE TECHNOLOGIES, LLC., Rockville, MD (US)

(72) Inventors: Isaac MIRANDA, Rockville, MD (US); Christopher BROOKS, Rockville, MD (US); Nataliya LAVRYKOVA-MARRAIN, Rockville, MD (US); Alan KISHBAUGH, Rockville, MD (US)

(21) Appl. No.: 18/658,062

(22) Filed: May 8, 2024

Related U.S. Application Data
(60) Provisional application No. 63/501,235, filed on May 10, 2023.

(51) Int. Cl. B01L 9/06

(52) U.S. Cl. CPC B01L 9/06

(57) ABSTRACT

The invention relates to a container for holding at least two vials. The container includes a back plate, a top wall, a bottom wall, a first sidewall and a second sidewall. The container also includes a clip disposed on a surface of the back plate, a first plurality of knobs and a second plurality of knobs. The container further includes cutouts in the bottom wall, the first sidewall and the second sidewall to allow access to the at least two vials within the container. The clip, the first plurality of knobs, and the second plurality of knobs are configured to retain the at least two vials within the container.

### CROSS REFERENCE TO RELATED APPLICATIONS

This application claims benefit to U.S. Provisional Application No. 63/501,235, filed May 10, 2023, the entire contents of which are hereby incorporated herein by reference.

### TECHNICAL FIELD

Embodiments hereof relate to a container, and more particularly, a container for holding one or more vials for storage and/or transportation.

### BACKGROUND

The process of packaging medical equipment, and more particularly vials, microtubes, screw-cap tubes and/or cryotubes, is a labor intensive process. There is a need for improved production, assembly and workflow. It is common practice in medical device and pharmaceutical production to store the boxes and containers that are used to ship and store vials in cold environments for long periods of time to preserve the contents of the vials. Many are frozen prior to shipment, are placed within a thermal insulating material, or are shipped with ice or other coolants. However, such shipping boxes and containers are regularly made of cardboard. Cardboard boxes often become soggy when the containers are temperature controlled by any of the methods mentioned above. Further, cardboard boxes often require multiple manual assembling steps prior to vial insertion, making the packaging process time consuming when large numbers of vials are shipped out together. Additionally, stackable boxes are preferred for improved inventory management.

Vials are also known to be quite difficult to load or remove, mainly due to the size and shape of the vials. Many vial containers require loading the vials into a small opening and sliding the vial into a tight sleeve or space in a rack. Thus, there is a need for a container that allows the vials to be loaded easily and efficiently, while still protecting the vials from damage during transportation.

### BRIEF SUMMARY

Embodiments of the present disclosure include a container for holding at least two vials including a first vial and a second vial. The container includes a back plate, a top wall extending from the back plate and at least one bottom wall extending from the back plate. The at least one bottom wall opposes the top wall. An unattached edge of the at least one bottom wall defines a first cutout on the at least one bottom wall to allow access to the first vial and the second vial within the container. The container further includes at least one first sidewall extending from the back plate between the top wall and the at least one bottom wall. An unattached edge of the at least one first sidewall defines a second cutout on the at least one first sidewall to allow access to the first vial within the container. The container further includes at least one second sidewall extending from the back plate between the top wall and the at least one bottom wall. The at least one second sidewall opposes the at least one first sidewall. An unattached edge of the at least one second sidewall defines a third cutout on the at least one second sidewall to allow access to the second vial within the container. The container further includes a clip disposed on the back plate. The clip defines a first curved surface and a second curved surface that opposes the first curved surface. The container further includes a first plurality of knobs including at least a first central knob disposed on the first curved surface of the clip and a first upper knob disposed on an interior surface of the at least one first sidewall. The first plurality of knobs are configured to permit the first vial to snap-fit within the container. The container further includes a second plurality of knobs including at least a second central knob disposed on the second curved surface of the clip and a second upper knob disposed on an interior surface of the at least one second sidewall. The second plurality of knobs are configured to permit the second vial to snap-fit within the container.

Embodiments of the present disclosure include a container for holding at least two vials including a first vial and a second vial. The container includes a rectangular back plate having a top end, a bottom end opposing the top end, a first side edge extending between the top end and the bottom end, and a second side edge opposing the first side edge. The container further includes a rectangular top wall extending perpendicularly from the top end of the back plate and a bottom wall extending perpendicularly from the bottom end of the back plate. The at least one bottom wall opposes the top wall. An unattached edge of the at least one bottom wall is concave and defines a first cutout on the at least one bottom wall. The container further includes at least one first sidewall extending perpendicularly from the first side edge of the back plate. An unattached edge of the at least one first sidewall is concave and defines a second cutout on the at least one first sidewall. The container further includes at least one second sidewall extending perpendicularly from the second side edge of the back plate. An unattached edge of the at least one second sidewall is concave and defines a third cutout on the at least one second sidewall. The container further includes a clip disposed on and coupled to a surface of the back plate. The clip has a generally T-shaped cross-section. The clip is disposed along a longitudinal axis of the back plate. The clip defines a first curved surface and a second curved surface that opposes the first curved surface. The container further includes a first plurality of knobs including a first central knob, a first upper knob, and a first lower knob. The first central knob is disposed on the first curved surface of the clip. The first upper knob and the first lower knob are each disposed on an interior surface of the at least one first sidewall. The container further includes a second plurality of knobs including a second central knob, a second upper knob, and a second lower knob. The second central knob is disposed on the second curved surface of the clip. The second upper knob and the second lower knob are each disposed on an interior surface of the at least one second sidewall. The first curved surface of the clip is configured to receive a portion of the first vial and the first plurality of knobs is configured to retain the first vial within a first space defined by the first curved surface, the at least one first sidewall, a first portion of the back plate, a first portion of the top wall, and a first portion of the at least one bottom wall. The second curved surface of the clip is configured to receive a portion of the vial and the second plurality of knobs is configured to retain the second vial within a second space defined by the second curved surface, the at least one second sidewall, a second portion of the back plate, a second portion of the top wall, and a second portion of the at least one bottom wall.

### BRIEF DESCRIPTION OF DRAWINGS

The foregoing and other features and advantages of the present invention will be apparent from the following description of embodiments hereof as illustrated in the accompanying drawings. The accompanying drawings, which are incorporated herein and form a part of the specification, further serve to explain the principles of various embodiments described herein and to enable a person skilled in the pertinent art to make and use various embodiments described herein. The drawings are not necessarily drawn to scale.

FIG. 1 illustrates a perspective top view of a container according to an embodiment hereof.

FIG. 2 illustrates a perspective front view of the container of FIG. 1.

FIG. 3 illustrates a front view of the container of FIG. 1.

FIG. 4 illustrates a perspective top view of the container of FIG. 1 holding two vials therein.

FIG. 5A illustrates a perspective front view of a container according to another embodiment hereof.

FIG. 5B illustrates a perspective bottom view of the container of FIG. 5A.

FIG. 6A illustrates a perspective front view of the container of FIG. 5A holding two vials therein.

FIG. 6B illustrates a perspective top view of the container of FIG. 5A holding two vials therein.

FIG. 7 illustrates a perspective back view of the container of FIG. 5A holding two vials therein.

FIG. 8 illustrates a container according to embodiments hereof being placed within a shipping sleeve or box according to embodiments hereof.

FIG. 9 illustrates a front view of a container configured to hold three vials according to embodiments hereof.

FIG. 10 illustrates a front view of a container configured to hold four vials according to embodiments hereof.

FIG. 11A illustrates a perspective top view of a container according to another embodiment hereof.

FIG. 11B illustrates a perspective front view of the container of FIG. 11A.

FIG. 11C illustrates a front view of the container of FIG. 11A.

FIG. 11D illustrates a perspective back view of the container of FIG. 11A.

FIG. 11E illustrates a perspective front view of the container of FIG. 11A holding two vials therein.

FIG. 11F illustrates the container of FIG. 11A with another container stacked thereon.

### DETAILED DESCRIPTION

Specific embodiments of the present invention are now described with reference to the figures. The following detailed description is merely exemplary in nature and is not intended to limit the present invention or the application and uses thereof. Furthermore, there is no intention to be bound by any expressed or implied theory presented in the preceding technical field, background, brief summary or the following detailed description.

Embodiments of the present disclosure are directed to a container for holding at least two vials. In embodiments, the container includes a clip and a plurality of knobs that allows a user to snap-fit the vials within the container. In embodiments, the container includes cutouts on the sides of the container that are designed to allow a user easy access when inserting and removing the vials. Additionally, the container includes a cutout on the bottom of the container which allows a user to inspect the contents of the vials without having to remove the vials from the container. In embodiments, the cutouts allow barcodes on the vials to be scanned without having the remove the vials from the container. Further, allowing the contents of the vials to be inspected, without needing to remove the vials from the container, expedites the loading, shipping and transporting process, as well as provides the end user easier access to the vials.

As used herein, the terms “top”, “bottom”, “side”, “back”, “front” are used herein for sake of illustration only and are not meant to be limiting. Stated another way, these terms are used to describe the relative relationship of different components of the container but are not meant to require any particular orientation or handling of the container.

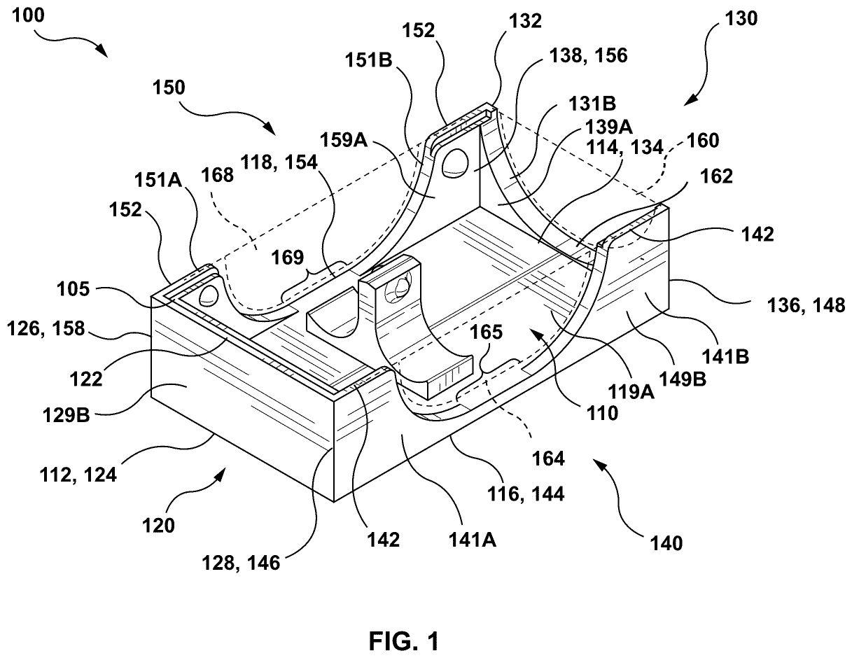

FIG. 1 illustrates a container 100 according to an embodiment hereof. The container 100 includes a back plate 110, a top wall 120, a bottom wall 130, a first sidewall 140 and a second sidewall 150. Each plate or wall of the container 100 is described individually herein in turn.

The back plate 110 is rectangular in shape and includes a top end 112, a bottom end 114 opposing the top end 112, a first side edge 116 extending between the top end 112 and the bottom end 114, and a second side edge 118 opposing the first side edge 116. The top end 112, bottom end 114, first side edge 116 and second side edge 118 of the back plate 110 define an interior surface 119A and an opposing exterior surface (not visible in FIGS. 1-4) of the back plate 110.

The top wall 120 of the container 100 is rectangular in shape and includes an unattached edge 122, a bottom edge 124 opposing the unattached edge 122, a first side edge 126 extending between the unattached edge 122 and the bottom edge 124, and a second side edge 128 opposing the first side edge 126. The unattached edge 122, bottom edge 124, first side edge 126 and second side edge 128 of the top wall 120 define an interior surface 129A and an opposing exterior surface 129B of the top wall 120. The unattached edge 122 of the top wall 120 is straight, as shown in FIG. 1.

The bottom wall 130 of the container 100 includes an unattached edge 132, a bottom edge 134 opposing the unattached edge 132, a first side edge 136 extending between the unattached edge 132 and the bottom edge 134, and a second side edge 138 opposing the first side edge 136. The unattached edge 132, bottom edge 134, first side edge 136 and second side edge 138 of the bottom wall 130 define an interior surface 139A and an opposing exterior surface 139B of the bottom wall 130. The bottom wall 130 further includes a first cutout or opening 160, which will be described in more detail below.

The first sidewall 140 of the container 100 includes an unattached edge 142, a bottom edge 144 opposing the unattached edge 142, a first side edge 146 extending between the unattached edge 142 and the bottom edge 144, and a second side edge 148 opposing the first side edge 146. The unattached edge 142, bottom edge 144, first side edge 146 and second side edge 148 of the first sidewall 140 define an interior surface (not visible in FIGS. 1-4) and an opposing exterior surface 149B of the first sidewall 140. The first sidewall 140 further includes a second cutout or opening 164, which will be described in more detail below.

The second sidewall 150 of the container 100 includes an unattached edge 152, a bottom edge 154 opposing the unattached edge 152, a first side edge 156 extending between the unattached edge 152 and the bottom edge 154, and a second side edge 158 opposing the first side edge 156. The unattached edge 152, bottom edge 154, first side edge 156 and second side edge 158 of the second sidewall 150 define an interior surface 159A and an opposing exterior surface (not visible on FIGS. 1-4) of the second sidewall 150. The second sidewall 150 further includes a third cutout or opening 168, which will be described in more detail below.

As described herein, the back plate, the top wall, the bottom wall, the first sidewall and the second sidewall of the container is formed integrally as a single piece or component. However, it should be understood that the back plate, the top wall, the bottom wall, the first sidewall and the second sidewall of the container may alternatively be separately formed and then assembled together in the configuration shown in FIG. 1. Assembling the container 100 may include thermoforming, laser fusing the components of the container 100 at their joining sides, and/or 3D printing the container 100 as a whole and/or 3D printing the components of the container 100 and assembling the components by methods discussed above.

As formed or when assembled, the top wall 120 extends perpendicularly from the top end 112 of the back plate 110. As such, the bottom edge 124 of the top wall 120 aligns or is formed integrally with the top end 112 of the back plate 110. The bottom wall 130 extends perpendicularly from the bottom end 114 of the back plate 110. As such, the bottom edge 134 of the bottom wall 130 aligns or is formed integrally with the bottom end 114 of the back plate 110. The first sidewall 140 extends perpendicularly from the first side edge 116 of the back plate 110. As such, the bottom edge 144 of the first sidewall 140 aligns or is formed integrally with the first side edge 116 of the back plate 110, the first side edge 146 of the first sidewall 140 aligns or is formed integrally with the second side edge 128 of the top wall 120, and the second side edge 148 of the first sidewall 140 aligns or is formed integrally with the first side edge 136 of the bottom wall 130. The second sidewall 150 extends perpendicularly from the second side edge 118 of the back plate 110. As such, the bottom edge 154 of the second sidewall 150 aligns or is formed integrally with the second side edge 118 of the back plate 110, the first side edge 156 of the second sidewall 150 aligns or is formed integrally with the second side edge 138 of the bottom wall 130, and the second side edge 158 of the second sidewall 150 aligns or is formed integrally with the first side edge 126 of the top wall 120.

As formed or when assembled as shown in FIGS. 1-4, the interior surface 129A of the top wall 120 faces or is oriented towards the bottom wall 130. Similarly, the interior surface 139A of the bottom wall 130 faces or is oriented towards the top wall 120. Further, the interior surface of the first sidewall 140 faces or is oriented towards the second sidewall 150. Similarly, the interior surface 159A of the second sidewall 150 faces or is oriented towards the first sidewall 140. The interior surface 119A of the back plate 110 faces or is oriented in the direction that the top wall 120, bottom wall 130, first sidewall 140 and second sidewall 150 extend from the back plate 110. Thus, the back plate 110, top wall 120, bottom wall 130, first sidewall 140 and second sidewall 150 collectively form or create a five-sided box-like structure. The container 100 may be considered to have an open front to allow for front loading of the vials. Stated another way, the container 100 does not include a front plate that opposes the back plate 110, but rather the front of the container 100 is open to the space or volume defined by the back plate 110, top wall 120, bottom wall 130, first sidewall 140, and second sidewall 150. The length, width, and height of the container 100 may vary depending on the size and number of vials to be received therein.

As mentioned previously, the bottom wall 130, the first sidewall 140 and the second sidewall 150 contain cutouts or openings 160, 164, 168, respectively. The cutouts are provided to allow the contents of the vials to be inspected without needing to remove the vials from the container. In addition, the cutouts allow the vials to easily be inserted and removed from the container by providing finger access to the tubular body of the vials. Lastly, the cutout of the bottom wall allows barcodes, often disposed on the bottom of the vials, to be scanned without needing to remove the vials from the container. FIG. 1 shows the shape of the cutouts 160, 164, 168 in phantom. As shown in FIGS. 1-4, each cutout 160, 164, 168 is substantially semi-circular shaped. However, this is not meant to be limiting, as the cutouts in each of the bottom wall 130, first sidewall 140 and second sidewall 150 may be of any suitable shape known to those of skill in the art, i.e., square-shaped, rectangle-shaped, triangle-shaped, oval-shaped, and the like. Although described herein as cutouts, it will be apparent to one of ordinary skill in the art that the sidewalls and bottom wall of the container 100 may be initially formed with the semi-circular openings. Stated another way, the walls 130, 140, 150 of the container 100 may initially be formed rectangular and the cutouts can be removed in a subsequent step, or alternatively the walls 130, 140, 150 of the container 100 may be initially formed in the shape depicted in the figures.

In the embodiment shown in FIGS. 1-4, due to the size and shape of the first opening or cutout 160 of the bottom wall 130, the bottom wall 130 is split into two separate walls or wall segments, namely a first bottom wall 131A that abuts the first sidewall 140 and a second bottom wall 131B that abuts the second sidewall 150 of the container 100. Stated another way, the first opening or cutout 160 extends to the bottom edge 134 of the bottom wall 130 such that the bottom wall 130 is split into the first and second bottom walls 131A, 131B that are not directly attached to each other. As used herein, although discontinuous, the first bottom wall 131A and the second bottom wall 131B collectively form the bottom wall 130 of the container 100 and are referred to collectively herein as the bottom wall 130. As can be seen in FIG. 1, a gap or space 162 is disposed along the bottom edge 134 of the bottom wall 130 between the first bottom wall 131A and the second bottom wall 131B. In an embodiment, the length of the gap 162 between the first bottom wall 131A and the second bottom wall 131B may extend between 10%-30% of a total length of the bottom wall 130. It is desirable to maximize the size of the cutout 160 in order to increase access to the vials held within the container 100, yet the size of the cutout 160 must be balanced against the size of the first and second bottom walls 131A, 131B which provide structural support to the container 100.

Each of the first bottom wall 131A and the second bottom wall 131B has a curved unattached edge which are collectively referred to herein as the unattached edge 132 of the bottom wall 130. The unattached edge 132 of the bottom wall 130 defines the first opening or cutout 160 of the bottom wall 130. To define the first opening or cutout 160 as substantially semi-circular shaped, at least a portion of the unattached edge 132 of the bottom wall 130 is concave. The cutout or opening 160 has a maximum length opposite from the back plate 110. The maximum length of the cutout or opening 160 may vary, depending upon the desired size of the opening, and in the embodiment of FIGS. 1-4, the maximum length of the cutout 160 extends the total length of the bottom wall 130. The large size of the cutout 160 ensures that the user can access barcodes on both vials received within the container 100. However, in another embodiment (not shown) in which the maximum length of the cutout 160 does not extend the total length of the bottom wall 130, the unattached edge 132 of the bottom wall 130 may include two straight portions or segments that extend parallel to the bottom edge 134, with the curved edge portions defining the cutout 160 disposed therebetween. In an embodiment, the maximum length of the cutout 160 may extend between 75%-100% of the total length of the bottom wall 130.

Similarly, in the embodiment shown in FIGS. 1-4, due to the size and shape of the second opening or cutout 164 of the first sidewall 140, the first sidewall 140 is split into two separate walls or wall segments, namely an upper first sidewall 141A that abuts the top wall 120 and a lower first sidewall 141B that abuts the bottom wall 130 of the container 100. Stated another way, the second opening or cutout 164 extends to the bottom edge 144 of the first sidewall 140 such that the first sidewall 140 is split into the upper and lower first sidewalls 141A, 141B that are not directly attached to each other. As used herein, although discontinuous, the upper first sidewall 141A and the lower first sidewall 141B collectively form the first sidewall 140 of the container 100 and are referred to collectively herein as the first sidewall 140. As can be seen in FIG. 1, a gap or space 165 is disposed along the bottom edge 144 of the first sidewall 140 between the upper first sidewall 141A and the lower first sidewall 141B. In an embodiment, the length of the gap 165 between the upper first sidewall 141A and the lower first sidewall 141B may extend between 10%-30% of a total length of the first sidewall 140. It is desirable to maximize the size of the cutout 164 in order to permit easy access to the vials held within the container 100, yet the size of the cutout 164 must be balanced against the size of the upper and lower first sidewalls 141A, 141B which provide structural support to the container 100.

Each of the upper first sidewall 141A and the lower first sidewall 141B has a curved unattached edge which are collectively referred to herein as the unattached edge 142 of the first sidewall 140. The unattached edge 142 of the first sidewall 140 defines the second opening or cutout 164 of the first sidewall 140. To define the second opening or cutout 164 as substantially semi-circular shaped, at least a portion of the unattached edge 142 of the first sidewall 140 is concave. The cutout or opening 164 has a maximum length opposite from the back plate 110. The maximum length of the cutout or opening 164 may vary, depending upon the desired size of the opening. As shown in the embodiment of FIGS. 1-4, the maximum length of the cutout 164 does not extend the total length of the first sidewall 140. The unattached edge 142 of the first sidewall 140 includes two straight segments that run parallel to the bottom edge 144, with the curved edge defining the cutout 164 disposed therebetween. However, in another embodiment (not shown), the maximum length of the cutout 164 extends the total length of the first sidewall 140. In an embodiment, the maximum length of the cutout 164 may extend between 50%-80% of the total length of the first sidewall 140.

Similarly, in the embodiment shown in FIGS. 1-4, due to the size and shape of the third opening or cutout 168 of the second sidewall 150, the second sidewall 150 is split into two separate walls or wall segments, namely an upper second sidewall 151A that abuts the top wall 120 and a lower second sidewall 151B that abuts the bottom wall 130 of the container 100. Stated another way, the second opening or cutout 168 extends to the bottom edge 154 of the second sidewall 150 such that the second sidewall 150 is split into the upper and lower second sidewalls 151A, 151B that are not directly attached to each other. As used herein, although discontinuous, the upper second sidewall 151A and the lower second sidewall 151B collectively form the second sidewall 150 of the container 100 and are referred to collectively herein as the second sidewall 150. As can be seen in FIG. 1, a gap or space 169 is disposed along the bottom edge 154 of the second sidewall 150 between the upper second sidewall 151A and the lower second sidewall 151B. In an embodiment, the length of the gap 169 between the upper second sidewall 151A and the lower second sidewall 151B may extend between 10%-30% of a total length of the second sidewall 150. It is desirable to maximize the size of the cutout 168 in order to permit easy access to the vials held within the container 100, yet the size of the cutout 168 must be balanced against the size of the upper and lower second sidewalls 151A, 151B which provide structural support to the container 100.

Each of the upper second sidewall 151A and the lower second sidewall 151B has a curved unattached edge which are collectively referred to herein as the unattached edge 152 of the second sidewall 150. The unattached edge 152 of the second sidewall 150 defines the second opening or cutout 168 of the second sidewall 150. To define the second opening or cutout 168 as substantially semi-circular shaped, at least a portion of the unattached edge 152 of the second sidewall 150 is concave. The cutout or opening 168 has a maximum length opposite from the back plate 110. The maximum length of the cutout or opening 168 may vary, depending upon the desired size of the opening. As shown in the embodiment of FIGS. 1-4, the maximum length of the cutout 168 does not extend the total length of the second sidewall 150. The unattached edge 152 of the second sidewall 150 includes two straight segments that run parallel to the bottom edge 154, with the curved edge defining the cutout 168 disposed therebetween. However, in another embodiment (not shown), the maximum length of the cutout 168 extends the total length of the second sidewall 150. In an embodiment, the maximum length of the cutout 168 may extend between 50%-80% of the total length of the second sidewall 150.

The container 100 further includes a lip or groove 105 disposed on all straight portions of the unattached edges 122, 132, 142, 152 of the walls 120, 130, 140, 150, respectively. More particularly, the groove 105 is disposed on the interior surfaces of the walls 120, 130, 140, 150, and are aligned relative to each other to form a discontinuous groove 105 that extends around the container 100. The groove 105 is discontinuous because it does not extend over the curved or concave portions of the unattached edges 132, 142, 152 of the bottom wall 130, first sidewall 140 and second sidewall 150 of the container 100. Rather, the groove 105 extends only over the straight segments or portions of the unattached edges 132, 142, 152 of the bottom wall 130, first sidewall 140 and second sidewall 150 to permit another container to be stacked or disposed thereon. More particularly, the groove 105 of the container 100 follows or extends on the straight segments of the unattached edges of the walls along the interior surfaces of the walls and provides a flat surface that allows an additional container to be stacked on top of the container 100. The groove 105 results in the straight portions of the unattached edges 122, 132, 142, 152 of the walls 120, 130, 140, 150 having a stepped profile. In an embodiment (not shown), an additional container to be stacked onto the container 100 would include a stepped profile on the exterior surface of the back plate 110 that fits or mates within the groove 105 of the container 100 such that the additional container may be stacked in a stable manner.

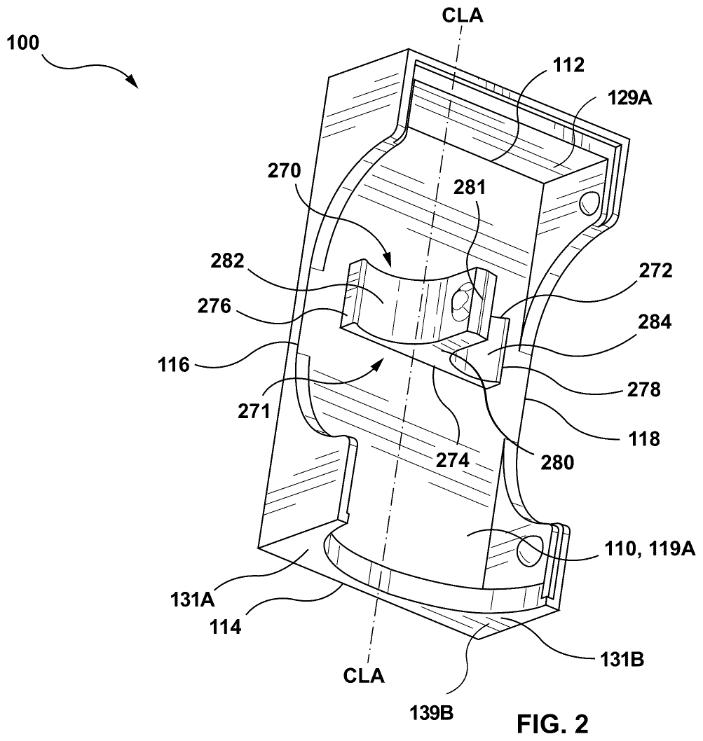

As best shown on FIG. 2, the container 100 also includes a clip 270. The clip 270 has a substantially T-shaped cross-section. The clip 270 includes a substantially rectangular-shaped flat surface 271 and a body 280. The flat surface 271 includes a top edge 272, a bottom edge 274 opposing the top edge 272, a first side edge 276 and a second side edge 278 opposing the first side edge 276. The clip 270 is disposed along a central longitudinal axis CLA of the back plate 110. The flat surface 271 of the clip 270 is coupled to the interior surface 119A of the back plate 110. More particularly, the flat surface 271 of the clip 270 is coupled to a middle or central portion of the interior surface 119A of the back plate 110 such that the top and bottom edges 272, 274 of the flat surface 271 are parallel to the top and bottom ends 112, 114 of the back plate 110 and the first and second side edges 276, 278 of the flat surface 271 are parallel to the first and second side edges 116, 118 of the back plate 110, as best shown in FIG. 2. The clip 270 may be formed integrally with the back plate 110 from which it protrudes, or may be formed as a separate component that is secured or attached to the back plate 110.

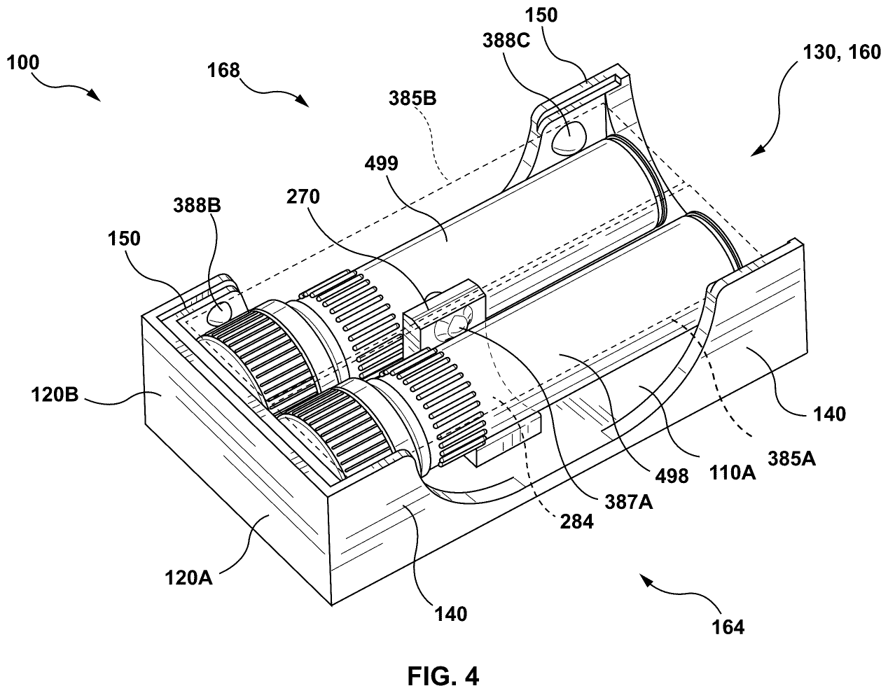

The body 280 of the clip 270 extends perpendicularly from the flat surface 271 of the clip 270. The body 280 of the clip 270 includes a front end 281, a first curved surface 282 and a second curved surface 284. The first curved surface 282 begins at the front end 281 of the body 280 and curves in a downward and outward direction until it reaches the first side edge 276 of the flat surface 271 of the clip 270. The second curved surface 284 begins at the front end 281 of the body 280 and curves in a downward and outward direction until it reaches the second side edge 278 of the flat surface 271 of the clip 270. As such, the first curved surface 282 of the body 280 extends outwards towards the first sidewall 140 of the container 100 and the second curved surface 284 of the body 280, opposite of the first curved surface 282, extends outwards towards the second sidewall 150 of the container 100. The first curved surface 282 is configured to receive a portion of a first vial and the second curved surface 284 is configured to receive a portion of a second vial. The curvature of the first and second curved surfaces 282, 284 of the clip 270 are configured to match the curvature of outer surfaces of the one or more vials that are received thereon, which will be described in further detail below with respect to FIG. 4.

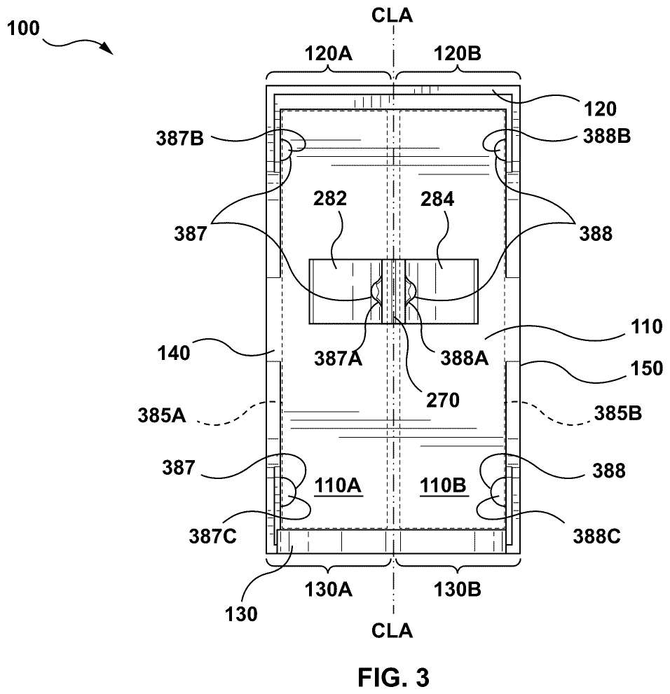

FIG. 3 shows the container 100 as viewed from the open-faced front of the container 100. As can be seen, the central longitudinal axis CLA runs through a center of the container 100, from the top wall 120 to the bottom wall 130 of the container 100. In FIG. 3, the top wall 120 of the container 100 is shown at the top, the bottom wall 130 of the container 100 is shown at the bottom, the first sidewall 140 is shown to the left of the CLA, and the second sidewall 150 is shown to the right of the CLA. The CLA runs through the body 280 of the clip 270 such that the first curved surface 282 of the clip 270 is disposed on the left of the CLA and the second curved surface 284 of the clip 270 is disposed on the right of the CLA.

As shown in FIG. 3, the CLA runs longitudinally through a center of the back plate 110 of the container 100, creating a first portion 110A of the back plate 110, disposed on one side of the CLA, and a second portion 110B of the back plate 110, disposed on the other side of the CLA, opposing the first portion 110A of the back plate 110. In FIG. 3, the first portion 110A of the back plate 110 is disposed on the left side of the CLA and the second portion 110B of the back plate 110 is disposed on the right side of the CLA. Similarly, the CLA runs through a center of the top wall 120, creating a first portion 120A and a second portion 120B of the top wall 120. In FIG. 3, the first portion 120A of the top wall 120 is disposed on the left side of the CLA and the second portion 120B of the top wall 120 is disposed on the right side of the CLA. Similarly, the CLA runs through a center of the bottom wall 130, creating a first portion 130A and a second portion 130B of the bottom wall 130. In FIG. 3, the first portion 130A of the bottom wall 130 is disposed on the left side of the CLA and the second portion 130B of the bottom wall 130 is disposed on the right side of the CLA.

With reference to FIG. 3, a first space or volume 385A is defined by the first portion 110A of the back plate 110, the first portion 120A of the top wall 120, the first portion 130A of the bottom wall 130, the first sidewall 140, and the first curved surface 282 of the clip 270. The first space 385A is configured to receive a portion of a first vial 498 within the container 100, which will be discussed in further detail below with reference to FIG. 4. A second space or volume 385B is defined by the second portion 110B of the back plate 110, the second portion 120B of the top wall 120, the second portion 130B of the bottom wall 130, the second sidewall 150, and the second curved surface 284 of the clip 270. The second space 385B is configured to receive a portion of a second vial 499 within the container 100, which will be discussed in further detail below with reference to FIG. 4.

The container 100 further includes a first plurality of knobs 387 and a second plurality of knobs 388. Each knob of the first and second pluralities knobs is dome-shaped and protrudes or extends from a surface of the container 100. Each knob may be formed integrally with the surface from which it protrudes, or each knob may be formed as a separate component that is secured or attached to the surface from which it protrudes. The first and second plurality of knobs 387, 388 are protrusions that are configured to prevent the first and second vials 498, 499 from falling out of the container 100 once they are inserted, which will be described in further detail below.

The first plurality of knobs 387 are disposed within the first space 385A of the container 100. The first plurality of knobs 387 includes at least a first central knob 387A, a first upper knob 387B and a first lower knob 387C. The first central knob 387A is disposed on the first curved surface 282 of the clip 270. More particularly, the first central knob 387A is disposed on the first curved surface 282 of the clip 270, as best shown in FIG. 1. The first central knob 387A extends away from the first curved surface 282 of the clip 270 towards the interior surface of the first sidewall 140 of the container 100. The first upper knob 387B is disposed on the interior surface of the first sidewall 140 adjacent to the top wall 120 of the container 100. The first upper knob 387B extends from the interior surface of the first sidewall 140 towards the second sidewall 150 of the container 100. The first lower knob 387C is disposed on the interior surface of the first sidewall 140 adjacent to the bottom wall 130 of the container 100. The first lower knob 387C extends from the interior surface of the first sidewall 140 towards the second sidewall 150 of the container 100. The first plurality of knobs 387 are configured to permit the first vial 498 to snap-fit within the first space 385A the container 100, which will be discussed in further detail below.

The second plurality of knobs 388 are disposed within the second space 385B of the container 100. The second plurality of knobs 388 includes at least a second central knob 388A, a second upper knob 388B and a second lower knob 388C. The second central knob 388A is disposed on the second curved surface 284 of the clip 270. More particularly, the second central knob 388A is disposed on the second curved surface 284 of the clip 270, directly opposite of the first central knob 387A. The second central knob 388A extends away from the second curved surface 284 of the clip 270 towards the interior surface of the second sidewall 150 of the container. The second upper knob 388B is disposed on the interior surface of the second sidewall 150 adjacent to the top wall 120 of the container 100, directly opposite of the first upper knob 387B. The second upper knob 388B extends from the interior surface of the second sidewall 150 towards the first sidewall 140 of the container 100. The second lower knob 388C is disposed on the interior surface of the second sidewall 150 adjacent to the bottom wall 130 of the container 100, directly opposite of the first lower knob 387C. The second lower knob 388C extends from the interior surface of the second sidewall 150 towards the first sidewall 140 of the container 100. The second plurality of knobs 388 are configured to permit the second vial 499 to snap-fit within the second space 385B of the container 100, which will be discussed in further detail below.

As best seen in FIG. 3, the first and second central knobs 387A, 388A have a substantially two-tiered shape. Each central knob 387A, 388A includes a base level that is formed integrally with or is attached to the first and second curved surface 282, 284 of the clip 270, respectfully, and a top level that extends from the base level. The base level of the first and second central knobs 387A, 388A has an outer surface or profile with a curvature that is configured to match the curvature of the outer surfaces of the one or more vials that are received thereon. The top level of the first and second central knobs 387A, 388A are substantially dome-shaped and are configured to extend over the one or more vials to retain the one or more vials within the container 100, which is discussed in further detail below.

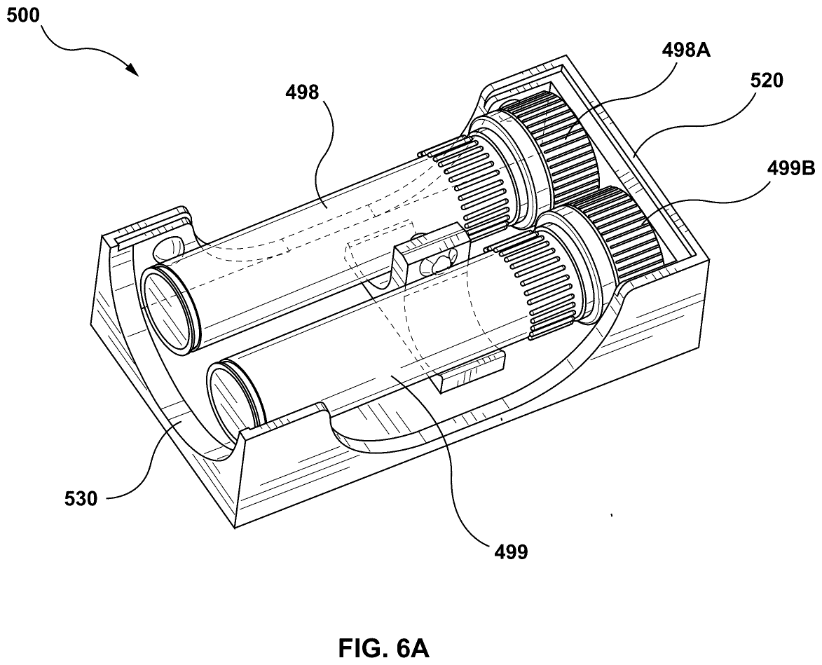

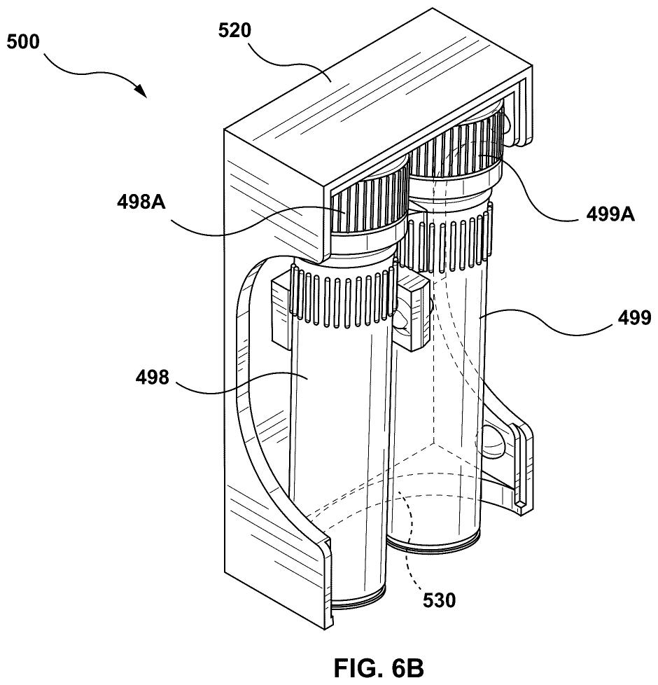

In an embodiment, the first and second upper knobs 387B, 388B are smaller in size, or have a smaller radius, than the first and second lower knobs 387C, 388C, as best shown in FIG. 3. The first and second upper knobs 387B, 388B do not have to be as large as the first and second lower knobs 387C, 388C because the first and second vials 498, 499 that are to fit within the first and second spaces 385A, 385B of the container 100 both include a cap 498A, 499A (as shown in FIGS. 6A and 6B) on a top end of each vial 498, 499, respectively. The caps 498A, 499A of the first and second vials 498, 499 have a larger diameter than the body of the vials 498, 499. Thus, the first and second upper knobs 387B, 388B that abut the caps 498A, 499A of the first and second vials 498, 499 are smaller to account for the larger diameter of the caps 498A, 499A. The first and second bottom knobs 387C, 388C that abut a bottom end of each vial 498, 499 are larger to account for the smaller diameter of the vials 498, 499 relative to the caps 498A, 499A of the vials 498, 499 disposed on the top ends of the vials 498, 499, respectively.

The embodiment described herein includes a first plurality of knobs that include exactly three knobs and a second plurality of knobs that include exactly three knobs, however this is not meant to be limiting, as more or fewer knobs can be used to achieve the same purpose. In addition, the embodiment described herein includes knobs of various shapes and sizes, however this is not meant to be limiting, as each of the knobs of the plurality of knobs can be the same in size and shape, or can vary in size and shape.

FIG. 4 shows the first vial 498 and the second vial 499 disposed within the container 100. As can be seen, the first vial 498 is received in the first space 385A of the container 100, defined by the first curved surface 282 of the clip 270, the first portion 110A of the back plate 110, the first portion 120A of the top wall 120, the first portion 130A of the bottom wall 130, and the first sidewall 140. The first plurality of knobs 387 are configured to retain the first vial 498 within the first space 385A. The second vial 499 is received in the second space 385B of the container 100, defined by the second curved surface 284 of the clip 270, the second portion 110B of the back plate 110, the second portion 120B of the top wall 120, the second portion 130B of the bottom wall 130, and the second sidewall 150. The second plurality of knobs 388 are configured to retain the second vial 499 within the second space 385B. As can be seen, a bottom end or surface of the first vial 498 and a bottom end or surface of the second vial 499 are disposed near the bottom wall 130 of the container 100 when the first and second vials 498, 499 are placed within the container 100. The top ends of the first and second vials 498, 499 are disposed near the top wall 120 of the container 100. The caps 498A, 499A of the first and second vials 498, 499 are disposed near the top wall 120 of the container 100. When the first and second vials 498, 499 are disposed within the container 100, the first and second plurality of knobs 387, 388 contact or abut each vial to hold the first and second vials 498, 499 within the container 100. The body 280 of the clip 270 is disposed between the first vial 498 and the second vial 499.

The first cutout 160 of the bottom wall 130 exposes at least a portion of the bottom end of the first vial 498 and at least a portion of the bottom end of the second vial 498. As such, the first cutout 160 allows barcodes, normally placed on the bottom ends of the vials 498, 499, to be scanned when the vials 498, 499 are disposed within the container 100. Stated another way, the vials 498, 499 do not have to be removed from the container 100 in order to scan the barcodes on the bottom ends of the vials 498, 499. The second cutout 164 of the first sidewall 140 exposes a portion of a body of the first vial 498 and the third cutout 168 of the second sidewall 150 exposes a portion of a body of the second vial 499, as shown in FIG. 4. The second and third cutouts 164, 168 of the sidewalls 140, 150 of the container 100 allow for inspection of the contents of the first and second vials 498, 499 without having to remove the first and second vials 498, 499 from the container 100. Additionally, the second and third cutouts 164, 168 of the sidewalls 140, 150 allow a user easy access to the vials 498, 499 when they are to be inserted and removed. Particularly, the cutouts 164, 168 allow easy finger access to the vials 498, 499 when they are in the container 100, making it easier for the user to insert and/or remove the vials 498, 499 from the container 100.

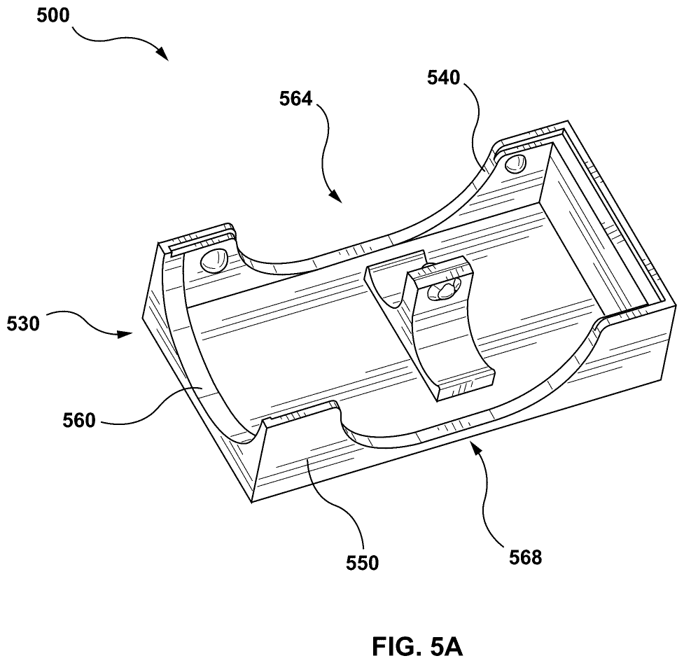

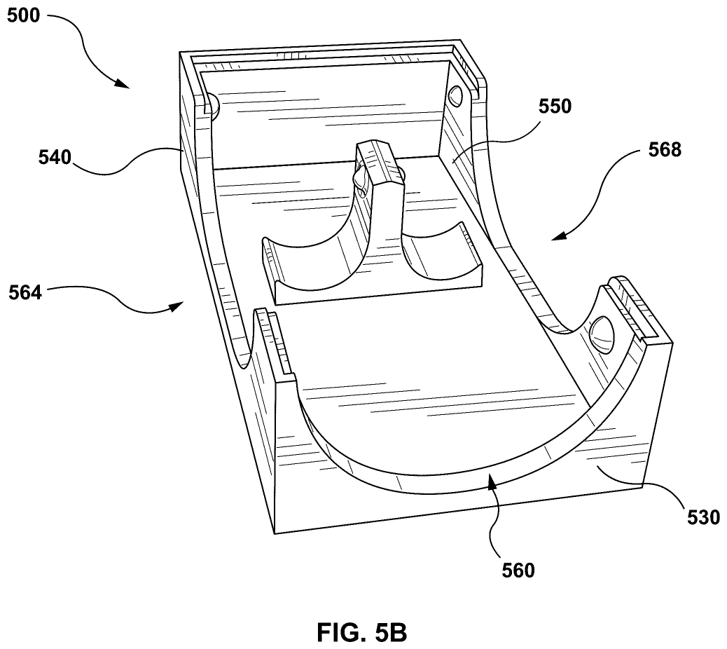

FIGS. 5A-5B show an alternate embodiment of a container 500. The container 500 is the same as the container 100 shown and described with regard to FIGS. 1-4, except that each of the bottom wall, first sidewall, and second sidewall of the container is a single continuous piece or part rather than split into two separate walls or wall segments. More particularly, a bottom wall 530 includes a first opening or cutout 560, a first sidewall 540 includes a second opening or cutout 564, and a second sidewall 550 includes a third opening or cutout 568. Each of the cutouts 560, 564, 568 extends less than a full height of the respective sidewall. The bottom wall 530, the first sidewall 540, and the second sidewall 550 are each one continuous part, with a semi-circular cutout formed thereon such that an unattached edge thereof includes a concave portion. In this embodiment, each of the cutouts 560, 564, 568 extends between 75% and 95% of a full height of the respective sidewall.

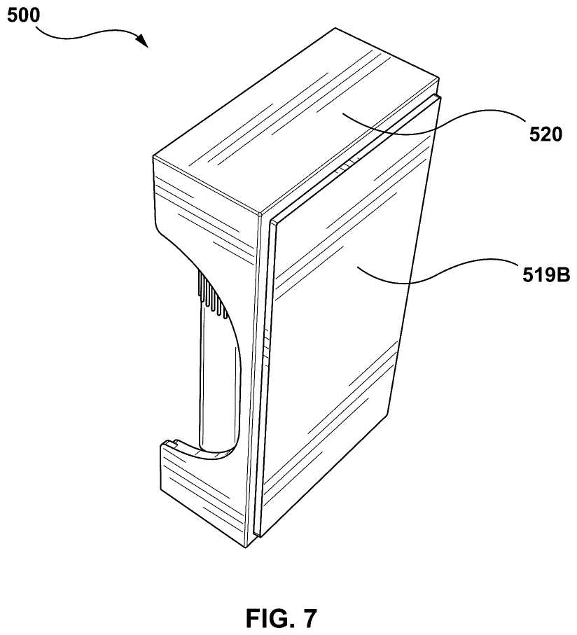

FIGS. 6A-6B show the first vial 498 and the second vial 499 within the container 500 of FIGS. 5A-5B. As can be seen, the cap 498A of the first vial 498 is coupled to the top end of the first vial 498 and is disposed near a top wall 520 of the container 500. Similarly, the cap 499A of the second vial 499 is coupled to the top end of the second vial 499 and is disposed near the top wall 520 of the container 500. An exterior surface 519B (shown on FIG. 7) of a back plate 510 of the container 500 can be laid flat on a surface, as shown in FIG. 6A, or the container 500 can be stood up such that the bottom wall 530 of the container 500 is laid flat on the surface, as shown in FIG. 6B. FIG. 7 shows the container 500 as viewed from the back, i.e., the exterior surface 519B of the back plate 510.

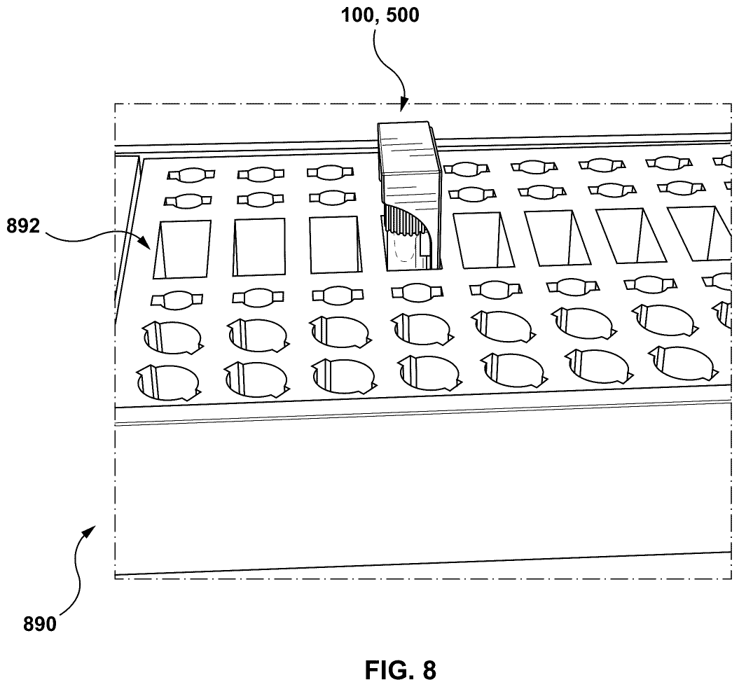

FIG. 8 shows a shipping box or container 890 used to store and ship multiple vial containers 100, 500 at once. As can be seen, the shipping box 890 includes a foam insert that has a plurality of openings 892. At least some of the openings of the plurality of openings 892 are sized and shaped to receive a container 100, 500. Other openings of the plurality of openings 892 are sized and shaped to receive various components of a kit, with the container 100, 500 being one component of the kit. The cutouts 164, 268, 564, 568 of the first and second sidewalls 140, 150, 540, 550, respectively, allow the contents of the vials 498, 499 to be seen even when the vials 498, 499 are within the container 100, 500 and placed in the shipping box 890.

For example, the shipping box or container 890 may store and ship a kit that optionally includes, in one or more separate vials, containers, or compartments, a labeling kit, as well as one or more additional reagents such as an assay buffer, diluent, read buffer, or combinations thereof. For example, the labeling kit can include, in one or more separate vials, containers, or compartments, SULFO-TAG™ NHS ester, LC-biotin NHS ester, a spin column, a labeling buffer solution, ECL read buffer, assay and antibody diluents, or combinations thereof.

In one specific embodiment, the shipping box or container 890 may store and ship a kit that includes a multi-well assay plate or cartridge or other solid phase which can be used to configure an end-user developed assay panel, i.e., an assay panel built by the end-user with his/her binding reagents to conduct an assay with the plate. In this embodiment, the end-user designates which binding reagent is bound to each binding domain. A multi-well assay plate or a cartridge or other solid phase is provided that includes a plurality of discrete binding domains including a first binding domain with a first targeting agent and a second binding domain with a second targeting agent and, optionally, additional binding domains with additional targeting agents. Each of the binding domains are functionalized by the user by selecting individual binding reagents that will be attached to each of the plurality of binding domains via a binding reagent complex, as described herein. In a separate vial, container, or compartment, a set of targeting reagents (each attached to a linking agent) is provided that includes a first targeting agent complement, a second targeting agent complement, an optionally additional targeting agent complements. The first targeting agent and first targeting agent complement and the second targeting agent and second targeting agent complement constitute a first and second pair of targeting agents, respectively. Similarly, any additional targeting agent complements form pairs with the different additional targeting agents on the binding domains. In one preferred embodiment, the targeting agents and targeting agent complements are oligonucleotides (i.e., an oligonucleotide and its complement).

Therefore, the user selects which targeting agent/targeting agent complement will be bound to each specific binding domain. The user also selects which binding reagent will be bound to each specific binding domain and forms a binding reagent complex that includes the targeting agent complement of the targeting agent attached to the designated binding domain. Alternatively, a multi-well assay plate or cartridge or other solid phase can be configured based on a user's specifications, e.g., from a catalog of available multiplexed assay panels and/or a user can select a set of analytes to configure a user-customized multiplexed assay for the set of analytes. A multiplexed assay panel should be selected and optimized such that individual assays function well together. For example, the sample may require dilution prior to being assayed. Sample dilutions for specific sample matrices of interest are optimized for a given panel to minimize sample matrix effects and to maximize the likelihood that all the analytes in the panel will be within the dynamic range of the assay. In a preferred embodiment, all of the analytes in the panel are analyzed with the same sample dilution in at least one sample type. In another preferred embodiment, all of the analytes in a panel are measured using the same dilution for most sample types.

The kit may provide reagents for the users to attach the supplementary linking agent to the users' binding reagents. When biotin is the supplementary linking agent, the kit may include biotin modified with a reactive functional group such as an NHS ester or hydrazide or maleimide. The plate and/or set of targeting reagents can further include a labeling kit for attaching a detectable label to an assay component, such as a detection reagent. For example, if the multi-well assay plate or cartridge is configured to conduct an electrochemiluminescence reaction, the labeling kit can include a SULFO-TAG™ NHS ester, LC-biotin NHS ester, an optional spin column, and optional labeling buffer solution. Further provided can be ECL read buffer and optional assay and antibody diluents.

The set of targeting reagents preferably includes a quantify of targeting reagents that matches the number of binding domains present in the multi-well plate or cartridge or other solid phase. For example, if the multi-well plate or cartridge or other solid phase includes ten discrete binding domains, a set of 10 targeting reagents are used with that multi-well plate or cartridge or other solid phase. The targeting agents may be provided with a linking agent that directly binds to the supplementary linking agent, e.g., streptavidin or avidin when the supplementary linking agent is biotin. When the linking agent and supplementary linking agent are configured to be linked through a bridging agent (e.g., when both the linking and supplementary linking agents are biotin), the kit may also provide a bridging reagent solution (e.g., a solution of streptavidin or avidin) that can be used to attach the binding reagent to the targeting agent complement. The kit may also provide a reaction buffer that provides the appropriate conditions for the linking/bridging reactions and a reaction stop solution. When one or more of the linking reagents are biotin, the stop solution may include free biotin to block any unused biotin-binding sites in streptavidin or avidin that is present as a linking agent, supplemental linking agent or bridging agent.

A wide variety of solid phases are suitable for use in the kits of the present invention including conventional solid phases from the art of binding assays. Solid phases may be made from a variety of different materials including polymers (e.g., polystyrene and polypropylene), ceramics, glass, composite materials (e.g., carbon-polymer composites such as carbon-based inks), biodegradable plastics, pressed or molded chipboards/cardboards and/or other paper products/materials known to those skilled in the art. Suitable solid phases include the surfaces of macroscopic objects such as an interior surface of an assay container (e.g., test tubes, cuvettes, flow cells, cartridges, wells in a multi-well plate, etc.), slides, assay chips (such as those used in gene or protein chip measurements), pins or probes, beads, filtration media, lateral flow media (for example, filtration membranes used in lateral flow test strips), etc. Suitable solid phases also include particles (including but not limited to colloids or beads) commonly used in other types of particle-based assays e.g., magnetic, polypropylene, and latex particles, materials typically used in solid-phase synthesis e.g. polystyrene and polyacrylamide particles, and materials typically used in chromatographic applications e.g., silica, alumina, polyacrylamide, polystyrene. The materials may also be a fiber such as a carbon fibril. Microparticles may be inanimate or alternatively, may include animate biological entities such as cells, viruses, bacterium and the like. A particle used in the present method may be comprised of any material suitable for attachment to one or more binding reagents, and that may be collected via, e.g., centrifugation, gravity, filtration or magnetic collection. A wide variety of different types of particles that may be attached to binding reagents are sold commercially for use in binding assays. These include non-magnetic particles as well as particles comprising magnetizable materials which allow the particles to be collected with a magnetic field. In one embodiment, the particles are comprised of a conductive and/or semiconductive material, e.g., colloidal gold particles. The microparticles may have a wide variety of sizes and shapes. By way of example and not limitation, microparticles may be between 5 nanometers and 100 micrometers. Preferably microparticles have sizes between 20 nm and 10 micrometers. The particles may be spherical, oblong, rod-like, etc., or they may be irregular in shape. The containers disclosed and described herein may be recycled and/or treated as biohazard after use.

In the embodiments shown and described herein, the container is configured to hold exactly two vials. However, this is not meant to be limiting, as the container may be configured to hold two or more vials, exactly three vials, exactly four vials, or exactly five vials.

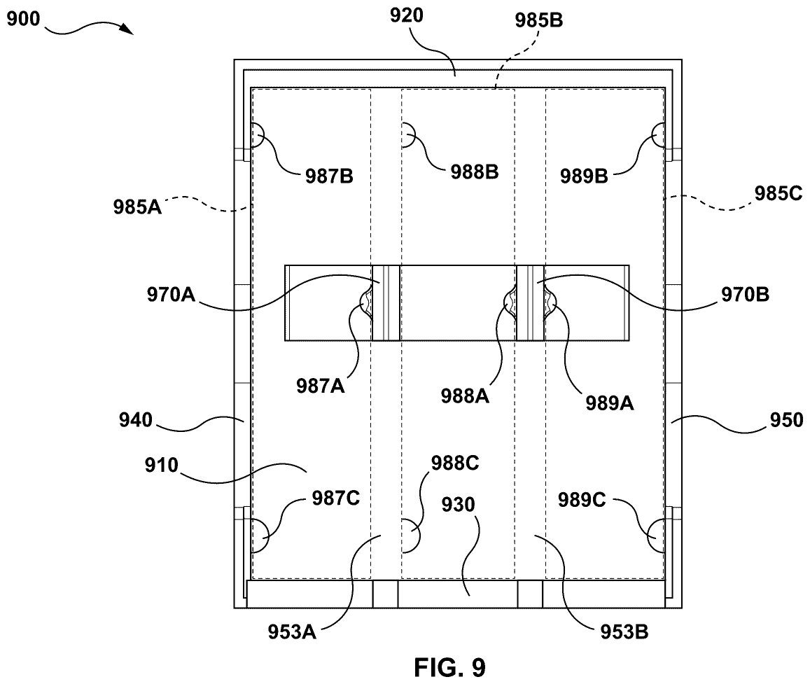

For example, FIG. 9 shows an alternate embodiment of a container 900 that is configured to hold exactly three vials. As can be seen, the container 900 includes a back plate 910, a top wall 920, a bottom wall 930, a first sidewall 940, a second sidewall 950, a first divider wall 953A and a second divider wall 953B. The first and second divider walls 953A, 953B are arranged parallel to the first and second sidewalls 940, 950 and are disposed in between the first sidewall 940 and the second sidewall 950. The bottom wall 930, first sidewall 940 and second sidewall 950 of the container 900 include cutouts similar or the same to those described above with regard to the containers 100, 500. The container 900 includes a first clip 970A and a second clip 970B, each of which is similar to the clip 270 described above. A first space 985A, defined by a portion of the back plate 910, a portion of the top wall 920, a portion of the bottom wall 930, the first sidewall 940, the first divider wall 953A, and a first curved surface of the first clip 970A, is configured to receive a first vial. A second space 985B, defined by a portion of the back plate 910, a portion of the top wall 920, a portion of the bottom wall 930, the first divider wall 953A, a second curved surface of the first clip 970A, the second divider wall 953B, and a first curved surface of the second clip 970B, is configured to receive a second vial. Lastly, a third space 985C, defined by a portion of the back plate 910, a portion of the top wall 920, a portion of the bottom wall 930, the second sidewall 950, the second divider wall 953B, and a second curved surface of the second clip 970B, is configured to receive a third vial.

As shown in FIG. 9, a first plurality of knobs within the first space 985A include a first central knob 987A disposed on the first curved surface of the first clip 970A, a first upper knob 987B disposed on an interior surface of the first sidewall 940 that faces the first space 985A and a first lower knob 987C disposed on an interior surface of the first sidewall 940 that faces the first space 985A that allow a first vial to snap-fit within the first space 985A of the container 900. A second plurality of knobs within the second space 985B include a second central knob 988A disposed on the first curved surface of the second clip 970B, a second upper knob 988B disposed on an interior surface of the first divider wall 953A that faces the second space 985B and a second lower knob 988C disposed on an interior surface of the first divider wall 953A that faces the second space 985B that allow a second vial to snap-fit within the second space 985B of the container 900. A third plurality of knobs within the third space 985C include a third central knob 989A disposed on the second curved surface of the second clip 970B, a third upper knob 989B disposed on an interior surface 959A of the second sidewall 950 that faces the third space 985C and a third lower knob 989C disposed on an interior surface of the second sidewall 950 that faces the third space 985C that allow a third vial to snap-fit within the third space 985C of the container 900.

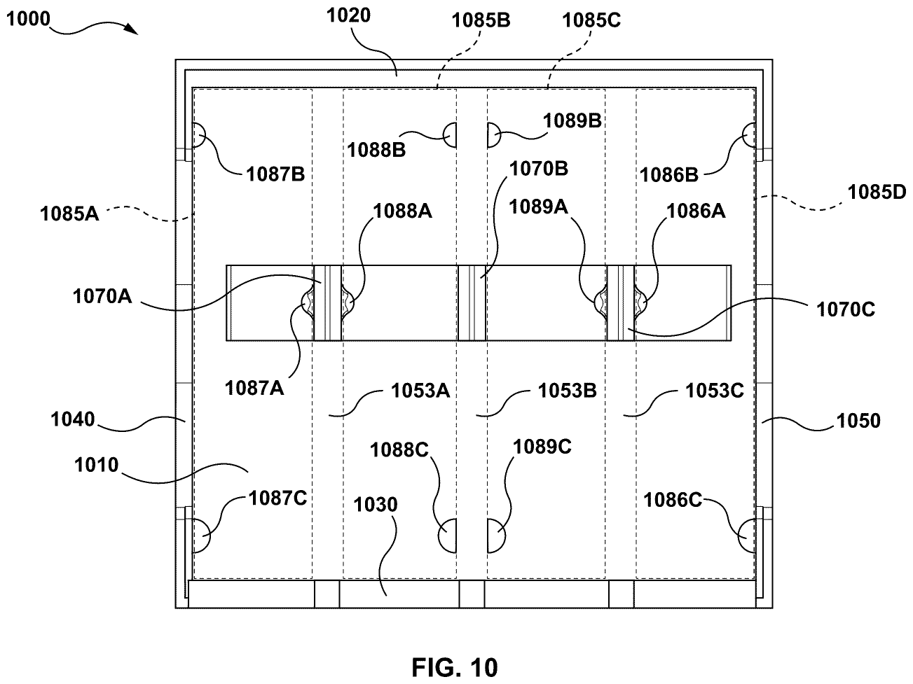

FIG. 10 shows an alternate embodiment of a container 1000 that is configured to hold exactly four vials. As can be seen, the container 1000 includes a back plate 1010, a top wall 1020, a bottom wall 1030, a first sidewall 1040, a second sidewall 1050, a first divider wall 1053A, a second divider wall 1053B and a third divider wall 1053C. The first, second, and third divider walls 1053A, 1053B, 1053C are arranged parallel to the first and second sidewalls 1040, 1050 and are disposed in between the first sidewall 1040 and the second sidewall 1050. The bottom wall 1030, first sidewall 1040 and second sidewall 1050 of the container 1000 include cutouts similar or the same to those described above with regard to the container 100, 500. The container 1000 includes a first clip 1070A, a second clip 1070B and a third clip 1070C, each of which is similar to the clip 270 described above. A first space 1085A, defined by a portion of the back plate 1010, a portion of the top wall 1020, a portion of the bottom wall 1030, the first sidewall 1040, the first divider wall 1053A, and a first curved surface of the first clip 1070A, is configured to receive a first vial. A second space 1085B, defined by a portion of the back plate 1010, a portion of the top wall 1020, a portion of the bottom wall 1030, the first divider wall 1053A, a second curved surface of the first clip 1070A, the second divider wall 1053B, and a first curved surface of the second clip 1070B, is configured to receive a second vial. A third space 1085C, defined by a portion of the back plate 1010, a portion of the top wall 1020, a portion of the bottom wall 1030, the second divider wall 1053B, a second curved surface of the second clip 1070B, the third divider wall 1053C, and a first curved surface of the third clip 1070C, is configured to receive a third vial. Lastly, a fourth space 1085D, defined by a portion of the back plate 1010, a portion of the top wall 1020, a portion of the bottom wall 1030, the second sidewall 1050, the third divider wall 1053C, and a second curved surface of the third clip 1070C, is configured to receive a fourth vial.

As shown in FIG. 10, a first plurality of knobs within the first space 1085A include a first central knob 1087A disposed on the first curved surface of the first clip 1070A, a first upper knob 1087B disposed on an interior surface of the first sidewall 1040 that faces the first space 1085A and a first lower knob 1087C disposed on an interior surface of the first sidewall 1040 that faces the first space 1085A that allow a first vial to snap-fit within the first space 1085A of the container 1000. A second plurality of knobs within the second space 1085B include a second central knob 1088A disposed on the second curved surface of the first clip 1070A, a second upper knob 1088B disposed on an interior surface of the second divider wall 1053B that faces the second space 1085B and a second lower knob 1088C disposed on an interior surface of the second divider wall 1053B that faces the second space 1085B that allow a second vial to snap-fit within the second space 1085B of the container 1000. A third plurality of knobs within the third space 1085C include a third central knob 1089A disposed on the first curved surface of the third clip 1070C, a third upper knob 1089B disposed on an interior surface of the second divider wall 1053B that faces the third space 1085C and a third lower knob 1089C disposed on an interior surface of the second divider wall 1053B that faces the third space 1085C that allow a third vial to snap-fit within the third space 1085C of the container 1000. Lastly, a fourth plurality of knobs within the fourth space 1085D include a fourth central knob 1086A disposed on the second curved surface of the third clip 1070C, a fourth upper knob 1086B disposed on an interior surface 1059A of the second sidewall 1050 that faces the fourth space 1085D and a fourth lower knob 1086C disposed on an interior surface 1059A of the second sidewall 1050 that faces the fourth space 1085D that allow a fourth vial to snap-fit within the fourth space 1085D of the container 1000.

From containers 900 and 1000 described above, it will be apparent to one of ordinary skill in the art that the containers described herein may be modified to receive any particular number of vials and embodiments depicting exactly two, three, and four vials are exemplary only.

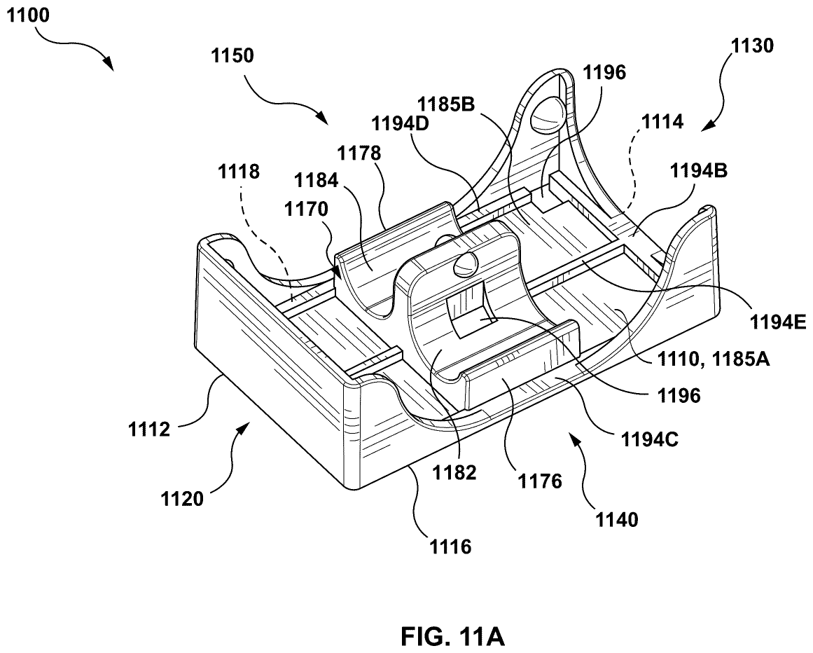

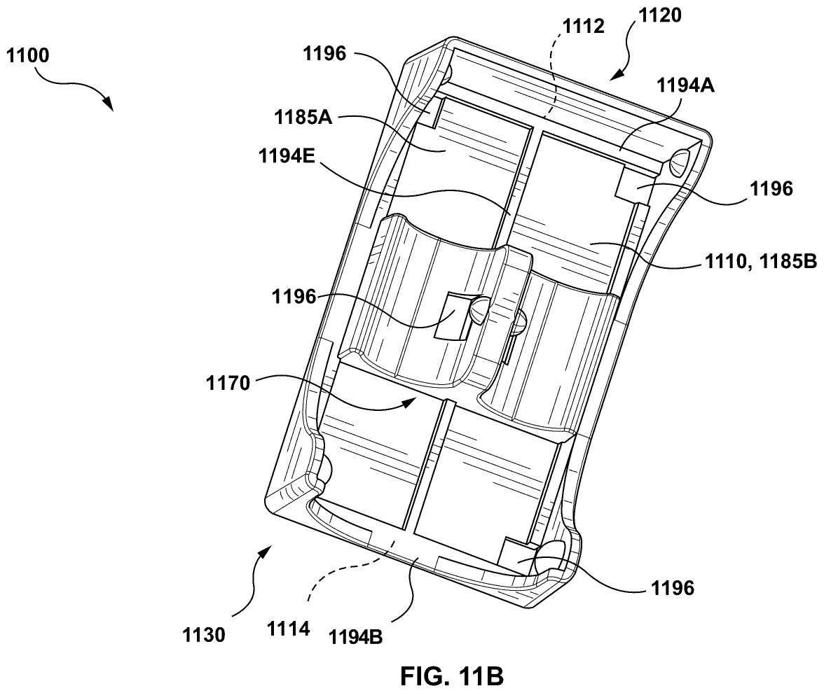

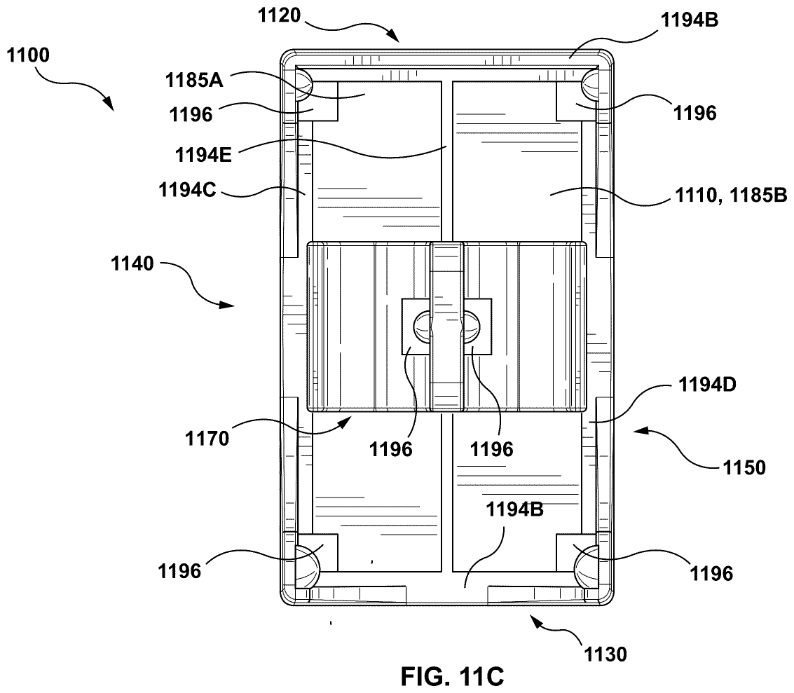

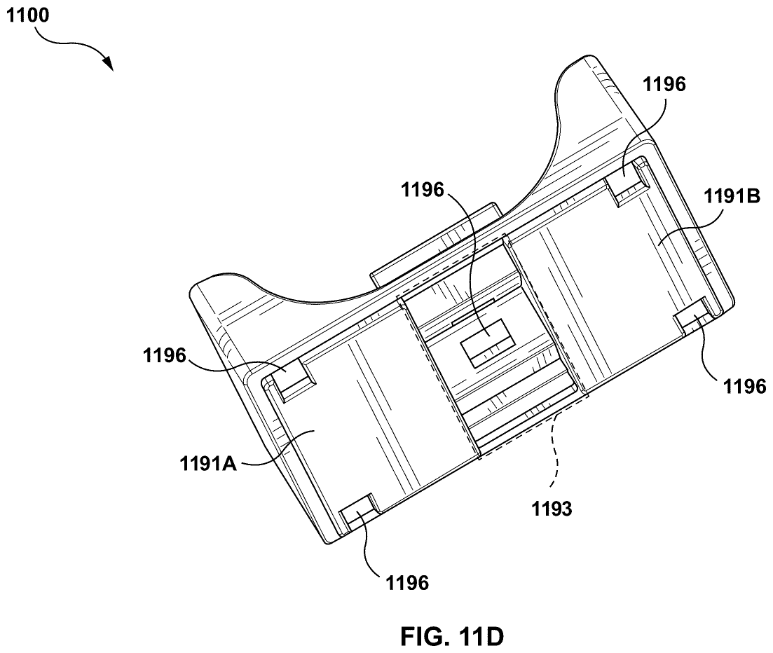

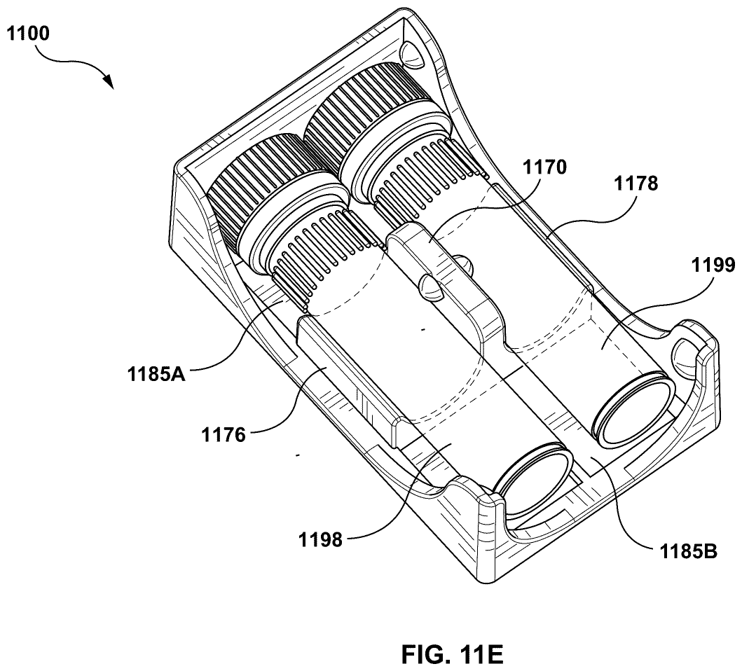

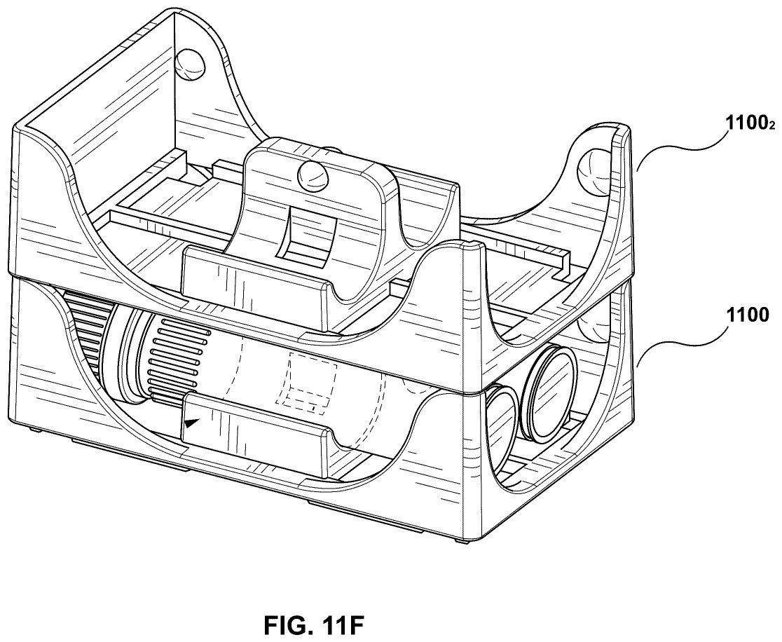

FIGS. 11A-11F show an alternate embodiment of a container 1100. The container 1100 is similar to the container 100 shown and described with regard to FIGS. 1-4, except for the differences described herein. In particular, a back plate 1110 of the container 1100 includes two separate parts and further includes a first indented space 1185A and a second indented space 1185B defined by a set of borders described in more detail herein. The container 1100 further includes a plurality of apertures 1196 disposed within the back plate 1110 and a clip 1170 of the container 1100 for manufacturing purposes, described in further detail below.

More particularly, FIG. 11A shows a perspective view of the container 1100. As can be seen, the container 1100 includes the back plate 1110, a top wall 1120, a bottom wall 1130, a first sidewall 1140 and a second sidewall 1150. The bottom wall 1130, first sidewall 1140 and second sidewall 1150 of the container 1100 include cutouts similar or the same to those described above with regard to the containers 100, 500. The container 1100 includes the first clip 1170 which is similar to the clip 270 described above, except that first and second side edges 1176, 1178 of the clip 1170 further extend away from an interior surface of the base plate 1110 to aid in securing first and second vials 1198, 1199 (shown in FIGS. 11E and 11F) within the container 1100, described in further detail below.

As best shown in FIGS. 11A-11C, the container 1100 includes the first indented space 1185A that is configured to receive a portion of the first vial 1198 within the container 1100 and the second indented space 1185B that is configured to receive a portion of the second vial 1199 within the container 1100, as similarly described above with regard to the first and second spaces 385A, 385B of the container 100. The first indented space 1185A and the second indented space 1185B are defined by a set of raised borders that are disposed on the interior surface of the back plate 1110 and line the outer edges of the back plate 1110 as well as a longitudinal line or axis that runs down the center of the back plate 1110. More particularly, as shown in FIGS. 11A-11C, a first border 1194A is disposed where a top end 1112 of the back plate 1110 aligns or is formed integrally with the top wall 1120, a second border 1194B is disposed where a bottom end 1114 of the back plate 1110 aligns or is formed integrally with the bottom wall 1130, a third border 1194C is disposed where a first side edge 1116 of the back plate 1110 aligns or is integrally formed with the first sidewall 1140, a fourth border 1194D is disposed where a second side edge 1118 of the back plate 1110 aligns or is integrally formed with the second sidewall 1150, and a fifth border 1194E is disposed parallel to the third and fourth borders 1194C, 1194D, extending longitudinally from the first border 1194A to the second border 1194B along a centerline or longitudinal axis of the back plate 1110. Accordingly, the first indented space 1185A is defined a portion of the first border 1194A, a portion of the second border 1194B, the third border 1194C and the fifth border 1194E and the second indented space 1185B is defined by a portion of the first border 1194A, a portion of the second border 1194B, the fourth border 1194C and the fifth border 1194E. The borders 1194 define the first and second indented spaces 1185A, 1185B to further secure the first and second vials 1198, 1199 when they are placed within the container 1100, as shown and described in reference to FIGS. 11E-11F.

The container 1100 further includes openings or apertures 1196 disposed in the back plate 1110 and the clip 1170 of the container 1100, as shown in FIGS. 11A-11F. As stated previously, the container 1100 may be formed integrally as a single piece or component. In an embodiment, the container 1100 may be manufactured as a single piece by injection molding. The apertures 1196 improve the manufacturing process by making it easier to remove the container 1100 from the mold once the process is complete. In the example shown in FIGS. 11A-11F, the apertures 1196 are substantially square-shaped and are disposed in each corner of the back plate 1110 and in the center of each curved surface 1182, 1184 of the clip 1170. However, this is not meant to be limiting, as the container 1100 can contain more or fewer apertures 1196 and the apertures 1196 can be any suitable shape known to those skilled in the art. Further, the apertures 1196 can be oriented in any suitable manner known to those skilled in the art.

FIG. 11D shows a perspective back view of the container 1100. As can be seen, the back plate 1110 is separated into two portions, a first portion 1191A and a second portion 1191B. A gap 1193 is disposed between the first portion 1191A and the second portion 1191B. In other words, the first portion 1191A and the second portion 1191B are spaced apart from one another such that there is the opening or gap 1193 extends between the first portion 1191A and the second portion 1191B. The gap 1193 is substantially rectangular-shaped and aligns with the position of the clip 1170 of the container 1100. The base plate 1110 having the gap 1193 removes material from the overall container 1100, making the container 1100 less expensive and lighter than if the base plate 1110 did not include the gap 1193. The base plate 1110 having the gap 1193 also improves the manufacturing process by making it easier to remove the container 1100 from the mold once the process is complete.

FIG. 11E shows first and second vials 1198, 1199 within the first and second indented spaces 1185A, 1185B of the container 1100, respectively. As can be seen, the first and second side edges 1176, 1178 of the clip 1170 secures the sides of the first and second vials 1198, 1199 within the clip 1170 of the container 1100. FIG. 11F shows an additional container 1100₂ stacked above the container 1100 of FIG. 11E.

All containers described herein may be formed from a thermoplastic material including but not limited to polylactic acid (PLA), acrylonitrile butadiene styrene (ABS), nylon, polycarbonate, polyethyelene, polypropylene, and the like. In an embodiment, all components of the container are integrally formed via any suitable method, including but not limited to 3D printing or injection molding.

Further embodiments of the present disclosure include at least the following:

Embodiment 1 is a container for holding at least two vials including a first vial and a second vial. The container includes a back plate, a top wall extending from the back plate and at least one bottom wall extending from the back plate. The at least one bottom wall opposes the top wall, wherein an unattached edge of the at least one bottom wall defines a first cutout on the at least one bottom wall to allow access to the first vial and the second vial within the container. The container includes at least one first sidewall extending from the back plate between the top wall and the at least one bottom wall, wherein an unattached edge of the at least one first sidewall defines a second cutout on the at least one first sidewall to allow access to the first vial within the container. The container includes at least one second sidewall extending from the back plate between the top wall and the at least one bottom wall, the at least one second sidewall opposing the at least one first sidewall, wherein an unattached edge of the at least one second sidewall defines a third cutout on the at least one second sidewall to allow access to the second vial within the container. The container includes a clip disposed on the back plate. The clip defines a first curved surface and a second curved surface that opposes the first curved surface. The container includes a first plurality of knobs including at least a first central knob disposed on the first curved surface of the clip and a first upper knob disposed on an interior surface of the at least one first sidewall. The first plurality of knobs are configured to permit the first vial to snap-fit within the container. The container includes a second plurality of knobs including at least a second central knob disposed on the second curved surface of the clip and a second upper knob disposed on an interior surface of the at least one second sidewall. The second plurality of knobs are configured to permit the second vial to snap-fit within the container.

Embodiment 2 is the container of embodiment 1, wherein each of the least one bottom wall, the at least one first sidewall, and the at least one second sidewall includes two walls.

Embodiment 3 is the container of either embodiment 1 or embodiment 2, wherein each of the least one bottom wall, the at least one first sidewall, and the at least one second sidewall is one continuous part.

Embodiment 4 is the container of any of embodiments 1-3, wherein an unattached edge of the top wall is straight.

Embodiment 5 is the container of any of embodiments 1-4, wherein an unattached edge of each of the at least one bottom wall, at least one first sidewall and at least one second sidewall is concave and defines each respective cutout.

Embodiment 6 is the container of any of embodiments 1-5, wherein a maximum length of the first cutout of the bottom wall is between 75% and 100% of a total length of the bottom wall and a maximum length of each respective cutout of the at least one first sidewall and the at least one second sidewall is between 50% and 80% of a total length of each respective sidewall.

Embodiment 7 is the container of any of embodiments 1-6, wherein the second cutout of the at least one first sidewall and the third cutout of the at least one second sidewall are configured to allow for inspection of vial contents when the first and second vials are within the container.

Embodiment 8 is the container of any of embodiments 1-7, wherein the clip has a generally T-shaped cross-section.

Embodiment 9 is the container of any of embodiments 1-8, wherein the clip is disposed along a central longitudinal axis of the back plate.

Embodiment 10 is the container of any of embodiments 1-9, wherein the first plurality of knobs and the second plurality of knobs are protrusions that prevent the first and second vials from falling out of the container once they are inserted.

Embodiment 11 is the container of any of embodiments 1-10, wherein each of the first and second pluralities of knobs include exactly three knobs: a central knob disposed on the clip, an upper knob disposed on an interior surface of the at least one first sidewall or the at least one second sidewall, and a lower knobs disposed on an interior surface of the at least one first sidewall or the at least one second sidewall.

Embodiment 12 is the container of any of embodiments 1-11, wherein the knobs of the first and second pluralities of knobs are the same size.

Embodiment 13 is the container of any of embodiments 1-12, wherein the knobs of the first and second pluralities of knobs are different in size.

Embodiment 14 is the container of any of embodiments 1-13, wherein the upper knobs are smaller than the lower knobs to accommodate the size of a first cap and a second cap of the first and second vials, respectively.

Embodiment 15 is the container of any of embodiments 1-14, wherein the container is configured to hold exactly two vials.

Embodiment 16 is the container of any of embodiments 1-15, wherein the container is configured to hold two or more vials, exactly three vials, exactly four vials, or exactly five vials.

Embodiment 17 is the container of any of embodiments 1-16, wherein the container does not include a front plate to allow for front loading of the vials.

Embodiment 18 is the container of any of embodiments 1-17, wherein an unattached edge of each of the top wall, the at least one bottom wall, at least one first sidewall and at least one second sidewall includes a stepped profile on straight portions thereof to form a discontinuous groove that extends around the container.

Embodiment 19 is the container of any of embodiments 1-18, wherein the discontinuous groove allows an additional container to be stacked thereon.

Embodiment 20 is a container for holding at least two vials including a first vial and a second vial. The container includes a rectangular back plate having a top end, a bottom end opposing the top end, a first side edge extending between the top end and the bottom end, and a second side edge opposing the first side edge. The container includes a rectangular top wall extending perpendicularly from the top end of the back plate, at least one bottom wall extending perpendicularly from the bottom end of the back plate, wherein the at least one bottom wall opposes the top wall. An unattached edge of the at least one bottom wall is concave and defines a first cutout on the at least one bottom wall. The container includes at least one first sidewall extending perpendicularly from the first side edge of the back plate, wherein an unattached edge of the at least one first sidewall is concave and defines a second cutout on the at least one first sidewall. The container includes at least one second sidewall extending perpendicularly from the second side edge of the back plate, wherein an unattached edge of the at least one second sidewall is concave and defines a third cutout on the at least one second sidewall. The container includes a clip disposed on and coupled to a surface of the back plate, wherein the clip has a generally T-shaped cross-section and the clip is disposed along a longitudinal axis of the back plate. The clip defines a first curved surface and a second curved surface that opposes the first curved surface. The container includes a first plurality of knobs including a first central knob, a first upper knob, and a first lower knob, the first central knob being disposed on the first curved surface of the clip and the first upper knob and the first lower knob each being disposed on an interior surface of the at least one first sidewall. The container includes a second plurality of knobs including a second central knob, a second upper knob, and a second lower knob, the second central knob being disposed on the second curved surface of the clip and the second upper knob and the second lower knob each being disposed on an interior surface of the at least one second sidewall. The first curved surface of the clip is configured to receive a portion of the first vial and the first plurality of knobs is configured to retain the first vial within a first space defined by the first curved surface, the at least one first sidewall, a first portion of the back plate, a first portion of the top wall, and a first portion of the at least one bottom wall. The second curved surface of the clip is configured to receive a portion of the vial and the second plurality of knobs is configured to retain the second vial within a second space defined by the second curved surface, the at least one second sidewall, a second portion of the back plate, a second portion of the top wall, and a second portion of the at least one bottom wall.

The embodiments described above are illustrative examples and it should not be construed that the present invention is limited to these particular embodiments. It should be understood that various embodiments disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the methods or processes). In addition, while certain features of embodiments hereof are described as being performed by a single module or unit for purposes of clarity, it should be understood that the features and functions described herein may be performed by any combination of units or modules. Thus, various changes and modifications may be affected by one skilled in the art without departing from the spirit or scope of the invention.

While various embodiments according to the present disclosure have been described above, it should be understood that they have been presented by way of illustration and example only, and not limitation. It will be apparent to persons skilled in the relevant art that various changes in form and detail may be made therein without departing from the spirit and scope of the present disclosure. Thus, the breadth and scope of the present disclosure should not be limited by any of the above-described exemplary embodiments but should be defined only in accordance with the appended claims and their equivalents. It will also be understood that each feature of each embodiment discussed herein, and of each reference cited herein, may be used in combination with the features of any other embodiment. Stated another way, aspects of the above multi-well plate may be used in any combination with other methods described herein or the methods may be used separately. All patents and publications discussed herein are incorporated by reference herein in their entirety.

What is claimed is:

1. A container for holding at least two vials including a first vial and a second vial, the container comprising:
a back plate;
a top wall extending from the back plate;
at least one bottom wall extending from the back plate, the at least one bottom wall opposing the top wall, wherein an unattached edge of the at least one bottom wall defines a first cutout on the at least one bottom wall to allow access to the first vial and the second vial within the container;
at least one first sidewall extending from the back plate between the top wall and the at least one bottom wall, wherein an unattached edge of the at least one first sidewall defines a second cutout on the at least one first sidewall to allow access to the first vial within the container;
at least one second sidewall extending from the back plate between the top wall and the at least one bottom wall, the at least one second sidewall opposing the at least one first sidewall, wherein an unattached edge of the at least one second sidewall defines a third cutout on the at least one second sidewall to allow access to the second vial within the container;
a clip disposed on the back plate, the clip defining a first curved surface and a second curved surface that opposes the first curved surface;
a first plurality of knobs including at least a first central knob disposed on the first curved surface of the clip and a first upper knob disposed on an interior surface of the at least one first sidewall, wherein the first plurality of knobs are configured to permit the first vial to snap-fit within the container; and
a second plurality of knobs including at least a second central knob disposed on the second curved surface of the clip and a second upper knob disposed on an interior surface of the at least one second sidewall, wherein the second plurality of knobs are configured to permit the second vial to snap-fit within the container.

2. The container of claim 1, wherein each of the least one bottom wall, the at least one first sidewall, and the at least one second sidewall includes two walls.

3. The container of claim 1, wherein each of the least one bottom wall, the at least one first sidewall, and the at least one second sidewall is one continuous part.

4. The container of claim 1, wherein an unattached edge of the top wall is straight.

5. The container of claim 1, wherein an unattached edge of each of the at least one bottom wall, at least one first sidewall and at least one second sidewall is concave and defines each respective cutout.

6. The container of claim 1, wherein a maximum length of the first cutout of the bottom wall is between 75% and 100% of a total length of the bottom wall and a maximum length of each respective cutout of the at least one first sidewall and the at least one second sidewall is between 50% and 80% of a total length of each respective sidewall.

7. The container of claim 1, wherein the second cutout of the at least one first sidewall and the third cutout of the at least one second sidewall are configured to allow for inspection of vial contents when the first and second vials are within the container.

8. The container of claim 1, wherein the clip has a generally T-shaped cross-section.

9. The container of claim 1, wherein the clip is disposed along a central longitudinal axis of the back plate.

10. The container of claim 1, wherein the first plurality of knobs and the second plurality of knobs are protrusions that prevent the first and second vials from falling out of the container once they are inserted.

11. The container of claim 1, wherein each of the first and second pluralities of knobs include exactly three knobs: a central knob disposed on the clip, an upper knob disposed on an interior surface of the at least one first sidewall or the at least one second sidewall, and a lower knob disposed on an interior surface of the at least one first sidewall or the at least one second sidewall.

12. The container of claim 1, wherein the knobs of the first and second pluralities of knobs are the same size.

13. The container of claim 1, wherein the knobs of the first and second pluralities of knobs are different in size.

14. The container of claim 11, wherein the upper knobs are smaller than the lower knobs to accommodate the size of a first cap and a second cap of the first and second vials, respectively.

15. The container of claim 1, wherein the container is configured to hold exactly two vials.

16. The container of claim 1, wherein the container is configured to hold two or more vials, exactly three vials, exactly four vials, or exactly five vials.

17. The container of claim 1, wherein the container does not include a front plate to allow for front loading of the vials.

18. The container of claim 1, wherein an unattached edge of each of the top wall, the at least one bottom wall, at least one first sidewall and at least one second sidewall includes a stepped profile on straight portions thereof to form a discontinuous groove that extends around the container.

19. The container of claim 18, wherein the discontinuous groove allows an additional container to be stacked thereon.

20. A container for holding at least two vials including a first vial and a second vial, the container comprising:
a rectangular back plate having a top end, a bottom end opposing the top end, a first side edge extending between the top end and the bottom end, and a second side edge opposing the first side edge;
a rectangular top wall extending perpendicularly from the top end of the back plate;
at least one bottom wall extending perpendicularly from the bottom end of the back plate, the at least one bottom wall opposing the top wall, wherein an unattached edge of the at least one bottom wall is concave and defines a first cutout on the at least one bottom wall;
at least one first sidewall extending perpendicularly from the first side edge of the back plate, wherein an unattached edge of the at least one first sidewall is concave and defines a second cutout on the at least one first sidewall;
at least one second sidewall extending perpendicularly from the second side edge of the back plate, wherein an unattached edge of the at least one second sidewall is concave and defines a third cutout on the at least one second sidewall;
a clip disposed on and coupled to a surface of the back plate, wherein the clip has a generally T-shaped cross-section and the clip is disposed along a longitudinal axis of the of back plate, the clip defining a first curved surface and a second curved surface that opposes the first curved surface;
a first plurality of knobs including a first central knob, a first upper knob, and a first lower knob, the first central knob being disposed on the first curved surface of the clip and the first upper knob and the first lower knob each being disposed on an interior surface of the at least one first sidewall; and
a second plurality of knobs including a second central knob, a second upper knob, and a second lower knob, the second central knob being disposed on the second curved surface of the clip and the second upper knob and the second lower knob each being disposed on an interior surface of the at least one second sidewall,
wherein the first curved surface of the clip is configured to receive a portion of the first vial and the first plurality of knobs is configured to retain the first vial within a first space defined by the first curved surface, the at least one first sidewall, a first portion of the back plate, a first portion of the top wall, and a first portion of the at least one bottom wall, and
wherein the second curved surface of the clip is configured to receive a portion of the second vial and the second plurality of knobs is configured to retain the second vial within a second space defined by the second curved surface, the at least one second sidewall, a second portion of the back plate, a second portion of the top wall, and a second portion of the at least one bottom wall.
